(19) United States
(12) Patent Application Publication
(10) Pub. No.: US 2023/0385733 A1
(43) Pub. Date: Nov. 30, 2023

(54) System and Method to Validate Task Completion

(71) Applicant: CareAR Holdings LLC, Norwalk, CT (US)

(72) Inventors: Chetan Gandhi, New York, NY (US); Kevin Summers, Richardson, TX (US)

(21) Appl. No.: 17/804,712

(22) Filed: May 31, 2022

(51) Int. Cl. G06Q 10/06; G06T 19/00

(52) U.S. Cl. CPC G06Q 10/0633; G06Q 10/063114; G06Q 10/06316; G06T 19/006

(57) ABSTRACT

A system for validating workflow task completion, includes a computer in communication with a user device that provides instructions related to a workflow and obtains an indicator input associated with a state of a monitored device, the computer having a deep learning module that receives the indicator input. The system includes a reference database storing reference data associated with different states of the monitored device, and a task database storing a plurality of workflow task steps. The deep learning module identifies an object of the monitored device within the indicator input, detects a state of the object by comparing the indicator input to at least one reference datum, and validates whether a current task step is completed based on the detected state of the object. The computer obtains another task step of the workflow based on a result of the validation and adjusts the instructions provided by the user device.

### TECHNICAL FIELD

The present disclosure is directed, in general, to augmented reality support systems, platforms, and/or applications that can be used by any user, for example service technicians or laymen, to step through a workflow or procedure.

### BACKGROUND

With computers and mobile devices becoming integral in every aspect of life, they are being increasingly used as the preferred medium to deliver instructions, procedures, or workflow task steps, such as setup instructions for installing a device, operating instructions on how to use a device, troubleshooting steps for repairing a malfunctioning machine, and maintenance procedures of an industrial process for conducting breakdown, corrective, and/or preventive maintenance. Typically, the instructions, procedures, or workflow task steps are presented collectively as a list in text format with or without exemplary illustrations. Recipients of instructions, however, often have difficulty in following the set of steps and understanding when proper conditions are present to know when a step has been completed. At times, recipients may inadvertently skip a step or misidentify a step as being correctly executed. It is up to the recipient to decide whether to transition from one task step to the next task step.

A service call to technical support may be made to seek assistance or remediation with a particular set of instructions. In order for the technical support to provide proper guidance, such service call still relies on the recipient being able to accurately explain the current conditions and/or state of a device, which may not always be the case. Further, the help and guidance from technical support is still given verbally, which is susceptible to misunderstanding by the recipient and typically results in inefficient calls.

Recently, augmented reality (AR) technologies have emerged as a way enhancing real world presentations with computer-generated data. As a basic example, a camera on a smartphone can be used to capture an image of a user's environment and present that image on the smartphone's display. An AR image may then be generated by overlaying text on the image labelling certain objects. In addition to visual enhancements, AR presentations may use other sensory modalities such as auditory, haptic, somatosensory and olfactory modalities to present relevant information to a user.

Accordingly, it is desired to leverage AR technologies to enhance how workflow instructions and guidance for stepping through the workflow are provided to end users.

### SUMMARY

Embodiments of the present teachings address and overcome one or more of the above shortcomings and drawbacks, by presenting systems, apparatuses, applications, and methods related to an AR-based platform that provides automated validation of task completion.

According to some embodiments, a system for validating workflow task completion includes a computer in data communication with a user device that is configured to provide instructions related to a workflow and configured to obtain an indicator input associated with a state of a monitored device. The state of the monitored device may be a physical state. The indicator input may comprise at least one image or video of the monitored device, a sound sample which captures an audio signature of the monitored device, and/or data from a sensor collection information about the monitored device. The computer receives the indicator input from the user device. The computer has a processor that processes the indicator input and a deep learning module that receives the processed indicator input. The system further includes a reference database that is in communication with the computer and a task database that is in communication with the computer. The reference database stores reference data associated with different states of the monitored device, and the task database stores a plurality of workflow task steps. The deep learning module identifies an object of the monitored device within the processed indicator input and detects a state of the object by comparing the processed indicator input to at least one reference datum from the reference database. The deep learning module validates whether a current task step of the workflow is completed based on the detected state of the object. The computer, in response to the validation, obtains another task step of the workflow based on a result of the validation and adjusts the instructions provided by the user device.

According to other embodiments, a system for validating workflow task completion includes a user device that is configured to provide instructions for a workflow which involves monitoring a device, and a computer in data communication with the user device, the computer being configured to receive sensor data originating from the monitored device via a network connection, the sensor data being indicative of a state of the monitored device and being received by the computer as an indicator input. The computer has a processor that processes the indicator input and a deep learning module that receives the processed indicator input. A task database in communication with the computer stores a plurality of workflow task steps. The deep learning module identifies an object of the monitored device, detects a state of the object based on the processed indicator input, and validates whether a current task step of the workflow is completed based on the detected state of the object. The computer, in response to the validation, obtains another task step of the workflow based on a result of the validation and adjusts the instructions provided by the user device.

The present teachings also relate to a method of validating workflow task completion. The method includes using a validation system, which includes a computer in data communication with a user device that is configured to provide instructions related to a workflow, wherein the workflow involves monitoring a device, obtaining an indicator input with the user device, the indicator input being associated with a state of a monitored device, transmitting the indicator input to a deep learning module of the computer, using the deep learning module to identify an object of the monitored device within the indicator input and to detect a state of the object by comparing the processed indicator input to at least one reference datum from a reference database, wherein the reference database is configured to be in communication with the computer and store reference data associated with different states of the monitored device, and validating, via the deep learning module, whether a current task step of the workflow is completed based on the detected state of the object. The method further includes in response to the validation, obtaining another task step of the workflow and adjusting the instructions provided by the user device based on a result of the validation, wherein the computer obtains the another task step from a task database which is configured to store a plurality of workflow task steps.

Additional features and aspects of the present teachings will become apparent from the following detailed description of illustrative embodiments that proceeds with reference to the accompanying drawings. This summary is not intended to limit the scope of the present teachings, which is defined by the claims.

### BRIEF DESCRIPTION OF THE DRAWINGS

FIG. 1 is a schematic view of a system for validating workflow task completion, according to some embodiments.

FIG. 2 is a schematic view of a system for validating workflow task completion, according to other embodiments.

FIG. 3 is a schematic view of a system for validating workflow task completion, according to other embodiments.

FIG. 4 is a flowchart detailing an exemplary method for validating task completion, according to some embodiments.

FIG. 5 is a flowchart detailing an exemplary method for validating task completion, according to other embodiments.

FIGS. 6A-6D illustrates an example of how the system for validating workflow task completion, according to some embodiments, provides augmented reality (AR) guidance to a user(s) for progressing through workflow task steps and validates workflow task completion.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any system configuration, device configuration, or processor configuration satisfying the requirements described herein may be suitable for implementing the system and method to validate task completion of the present embodiments.

For purposes of explanation and not limitation, specific details are set forth such as particular structures, architectures, interfaces, techniques, etc. in order to provide a thorough understanding. In other instances, detailed descriptions of well-known devices and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

As used herein, the term “workflow” encompasses any sequence of steps, tasks, instructions, actions, and/or events involved in moving from the beginning to the end of a process, procedure, plan, program, project, operation, transaction, or the like, which leads to a result.

Systems, applications, and methods are described herein which relate generally to an AR-based platform that provides guidance through workflow task steps. One or more of the task steps each may be associated with a state or condition of a device (e.g., mechanical, electrical, electromechanical), or a state or condition of a specific object/component of the device. The state or condition may be a physical state of the monitored device or an object/component thereof. For example, a task step may correspond to whether the front door of a printer is in an open state. In addition, or alternatively, the one or more task steps may be each associated with the presence or absence of an object/component of the device. As an example, a task step may correspond to a state when a toner cartridge is absent or missing from the printer. The AR-based systems, applications, and methods improves guidance through a workflow by validating proper completion of the workflow task steps. The AR-based systems, applications, and methods facilitate a user's progress through a workflow by confirming that a current task step has been completed and by controlling the delivery of subsequent task steps to the user until completion of the current task step is confirmed.

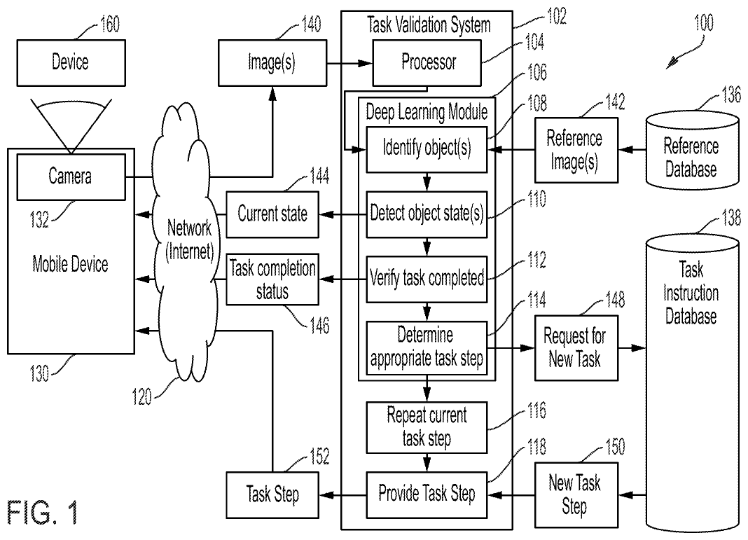

Referring to the figures in detail and first to FIG. 1, there is shown a system 100 for validating workflow task completion according to some embodiments. The workflow task validation system 100 is designed to deliver workflow task steps to a user (e.g., mobile device 130) and provide guidance as the user proceeds through the workflow. The workflow task validation system 100 may comprise a computer system, server, or other processing device 102 and includes a processing unit with one or more processors 104. Additionally, the computer system 102 may include memory, input/output devices, storage, and communication interfaces—all connected by a communication bus. The storage may store application programs and data for use by the computer system 102. Typical storage devices include hard-disk drives, flash memory devices, optical media, network and virtual storage devices, and the like. The communication interfaces may connect the workflow task validation system 100 to any kind of data communications network, including either wired networks, wireless networks, or a combination thereof. The memory may be random access memory sufficiently large to hold necessary programming and data structures of the disclosed subject matter. The memory may constitute a single entity or comprise a plurality of modules. The input/output devices may be used to update and view information stored in a reference database 136 and/or task instruction database 138, as described later in more detail.

The workflow task validation system 100 is configured to communicate through a network 120 with a user device 130 that is associated with a user who is carrying out or planning to carry out a workflow. The network 120 may comprise a local-area network (LAN), a wide-area network (WAN), metropolitan-area network (MAN), and/or the Internet, and further may be characterized as being a private or public network. The user device 130 may comprise a mobile device, such as a mobile phone, smart glasses, AR/VR glasses, personal digital assistant, tablet, laptop, or the like. However, in other embodiments, the user device 130 may be a non-mobile device, for example a desktop computer. The user device 130 contains an application(s) which, when executed by a processor of the user device 130, delivers workflow task steps from the computer system 102 to the user and provides real-time guidance as the user progresses through the workflow. The application(s) of the user device 130 generates graphical user interfaces for presenting the workflow task steps (e.g., one by one) and facilitates user interaction with the graphical user interfaces(s) as described herein.

The user device 130 is configured obtain an indicator input associated with a state or condition (e.g., physical state) of a device 160 which is involved in the workflow and is monitored and/or manipulated during performance of the workflow. Herein, the device 160 is referred to as a “monitored device.” The indicator input may comprise one or more images 140, or one or more frames of a video, as shown in FIG. 1. The user device 130 comprises a camera 132 or other similar imaging device. For example, the camera 132 may include a CCD sensor, a CMOS sensor, or a combination of both. The camera is adapted to capture at least one static image, or a video (a plurality of moving images), or a combination of both of the monitored device 160. In addition, or alternatively, the camera captures an image and/or a video of a particular component or object of the monitored device 160. For example, in a workflow for removing a paper jam in a printer, the monitored device 160 is the printer and the camera 132 captures an image of the front door of the printer. In another example where the workflow relates to setup of a Wi-Fi network, the monitored device 160 may be a network router and the camera 132 captures an image of the router's LED status panel. In yet another example where the workflow relates to changing a brake pad of a car, the monitored device 160 may be the brake caliper assembly and the camera 132 captures an image of the retaining clips holding the old brake pad in place.

Upon capturing the image(s) 140, the user device 130 is configured to transmit it over the network 120 to the task validation system 100. At least one processor 104 of the computer system 102 is configured to perform digital image processing on the image(s) 140. For example, the user device 130 may transmit the image(s) 140 in compressed format, which is then decompressed by the processor 104. In some embodiments, the processor 104 may enhance the image(s) 140 in order to extract hidden details from the image. This will improve the capability of the task validation system 100 to accurately validate that a current task step has been completed. Other image processing operations that may be conducted by the processor 104 include, but are not limited to, image restoration, color image processing, morphological processing, and segmentation. Different attributes of the image(s) may also be adjusted, such as contrast, brightness, sharpness, dimensions, and/or resolution. Also, if the user device 130 transmits a video to the task validation system 100, the processor 104 may be configured to extract at least one image or frame from the video to serve as an indicator input for analysis by the task validation system 100.

It is noted that the user device 130 and the task validation system 100 may be configured to stream the image(s) or video(s) 140. For example, while the camera 132 is capturing a video, the user device 130 actively or simultaneously transmits the video 140 for receipt by the processor 104. In turn, the processor 104 processes the video 140 in real-time.

The computer system 102 also includes a deep learning module 106 that performs the operations necessary for validating in real-time the completion of a task step currently performed by the user. The deep learning module 106 may comprise a machine learning processor, a deep learning accelerator, an AI accelerator, and/or neural processor. The deep learning module 106 is built on machine learning and/or artificial intelligence and may be based on artificial neural networks with representation and/or reinforcement learning, in order to provide automated validation of task completion. In some embodiments, the deep learning module is a deep learning machine that uses neural networks. In some embodiments, the deep learning module may comprise computer instructions executable on a processor for validating the completion of a task step and may constitute a determination module. In some embodiments, the deep learning module 106 includes computer vision (with pattern recognition capability, for example) and has been trained to visually detect objects/components of the monitored device 160 and their respective states and conditions from the image(s) 140. In addition, or alternatively, the deep learning module 106 has been trained to visually detect the monitored device 160 as a whole and determine its state or condition from the image(s) 140.

The deep learning module 106 is configured to analyze the indicator input (e.g., image(s) 140), specifically identifying 108 an object of the monitored device 160 within the image(s) 140 and detecting 110 a state of the object by comparing the image(s) 140 to at least one reference datum (e.g., reference image 142). As shown in FIG. 1, the system 100 for validating workflow tasks includes a reference database 136 in communication with the computer system 102. The reference database 136 stores reference data, such as a plurality of reference images 142 associated with different states or conditions of the monitored device 160 and/or a plurality of reference images 142 associated with different states or conditions of an object/component of the monitored device 160. For each state of the monitored device 160 (and for example, for each state of an object/component of the monitored device 160), the reference database 136 may store only one reference image 142 or multiple reference images 142 related thereto. It is understood that with multiple reference images, the deep learning module is able to better identify an object of the monitored device and detect its state. However, even if the reference database contains one image of the object in a particular state, the deep learning module still has the capacity to identify that object and detect that particular state of the object. The identification 108 and detection 110 may function by comparing, e.g., matching, the image(s) 140 to a reference image(s) 142, and using metadata contained in the matching reference image to detect the current state of the monitored device. The metadata may comprise a description of the state of the monitored device that is depicted in the corresponding reference image. Once the identification 108 and detection 110 have been performed, the deep learning module 106 may transmit the current state 144 to the user device 130 via the network 120. The user device 130 can then present the current state information of the monitored device 160 in its user interface.

An exit criteria or requirement for validation of a task step may be defined in the task step itself. For example, if a task step is to open the front door of a printer, then the deep learning module 106 is trained to recognize and differentiate a front door closed state and a front door open state via reference images and/or videos. In some embodiments, the deep learning module is provided with training data, such as a set of reference images and/or reference videos of an object of the monitored device (e.g., printer front door), wherein each reference datum has been labeled with metatags or metadata describing the state or condition of the object (e.g., front door open or front door closed) shown in the respective datum. The deep learning module uses the information it receives from the training data to create a feature set for “open front door” and/or a feature set for “closed front door,” and builds a predictive model(s) accordingly. With each reference datum, the model becomes more complex and more accurate. As described above, the deep learning module may comprise artificial neural networks, comprising many layers, which drive deep learning. Each layer of the neural networks can perform complex operations, for example representation abstraction, extraction, and more, that make sense of the training data (e.g., reference images, reference videos). The training data may be stored in the reference database 136.

After the identification operation 108 and detection operation 110, the deep learning module verifies or validates 112 whether a current task step of the workflow has been completed by the user based on the detected state of the object of the monitored device 160. The deep learning module 106 may, in some embodiments, transmit a status 146 of task completion to the user device 130 via the network 120. This enables the user device 130 to indicate in real-time to the user whether and when a task step has been completed and when it is proper to move forward in the workflow.

Using the example where the current task step is to open the front door of the printer, when the deep learning module 106 analyzes the indicator input, e.g., image(s) 140, from the user device 130 and detects the front door open state, the deep learning module verifies 112 that the task step has indeed been completed. The deep learning module 106 then determines an appropriate task step 114 to be presented on the user device 130. This determination operation 114 functions in response to the results of the verification operation 112. When there is a positive verification and validation of the current task step being completed, the deep learning module 106 requests a new task, i.e., next task step, in the workflow. For example, the determination operation 114 of the deep learning module sends a request signal 148 to a task instruction database 138, which is in data communication with the computer system 102. The task instruction database 138 stores a plurality of workflow task steps or instructions and for example, all the task steps involved in removing a paper jam in the printer. In some embodiments, the task instruction database 138 uses information obtained from the computer system 102 and relating to the current task step that was completed and verified in order to decide which next task step 150 to send to the computer system 102. Using the example where the current task step is to open the front door of the printer, when the deep learning module 106 analyzes the indicator input, e.g., image(s) 140, from the user device 130 and detects the front door closed state (or a front door partially open state), the verification operation 112 determines that the current task step has not been completed, i.e., incomplete. In response to the negative result of the verification operation 112, the determination operation 114 functions by indicating to the computer system 102 that the current task step needs to be repeated or still requires completion 116. In other embodiments, when the verification operation 112 concludes that the user has failed to complete the current task step, the determination operation 114 may instead send a request signal 148 to the task instruction database 138 to obtain a new task step 150 in the form of a troubleshooting step. This process may temporarily pause any instructions for the relevant workflow and initiate a troubleshooting workflow to be presented to the user device 130.

The computer system 102 performs an operation 118 of providing the appropriate task step to the user device 130, whether it be a new task step 150 in the workflow or a repeat 116 of the current task step which has yet to be completed. As such, a task step signal 152 is transmitted from the task validation system 100 through the network 120 to the user device 130 for display. Thereafter, the same process and mechanisms are used to validate subsequent task steps in the workflow, thereby facilitating the user in properly advancing through the workflow.

In some embodiments, the deep learning module 106 is configured to analyze the indicator input, e.g., image(s) 140, in such a way that it identifies 108 a plurality of objects within the indicator input and detects a state of each object by comparing the indicator input with at least one reference datum, e.g., reference image 142. Using the example where the current task step is to open the front door of the printer, the object identification operation 108 may recognize the front door and a release latch on the front door. The state detection operation 110 of the deep learning module 106 then detects the states of both the front door (e.g., open, closed) and the release latch (e.g., engaged-disengaged, raised-depressed). By obtaining the states of multiple objects of the monitored device 160, the task validation system 100 is able to provide better or improved validation of task completion. In addition, or alternatively, the task validation system 100 may deliver better troubleshooting assistance to the user device 130 if the user is having difficulty completing the current task step. The determination operation 114, for example, can transmit a request 148 to the task instruction database 138 with information pertaining to the states of the multiple objects of the monitored device 160, so that an appropriate troubleshooting step is identified by the deep learning module 106 and/or task instruction database 138, then transmitted to the computer system 102, and subsequently delivered to the user device 130.

FIG. 1 shows the reference database 136 and the task instruction database 138 as separate devices from the computer system 102. The reference database and the instruction database can each be cloud servers. However, in some embodiments, the reference database 136 and/or the task instruction database 138 may form a part of the computer system 102. In yet other embodiments, the computer system 102, reference database 136, and task instruction database 138 may constitute a single structural device. Further, the reference database 136 and the task instruction database 138 may be combined into a single database server that is in data communication with the computer system 102.

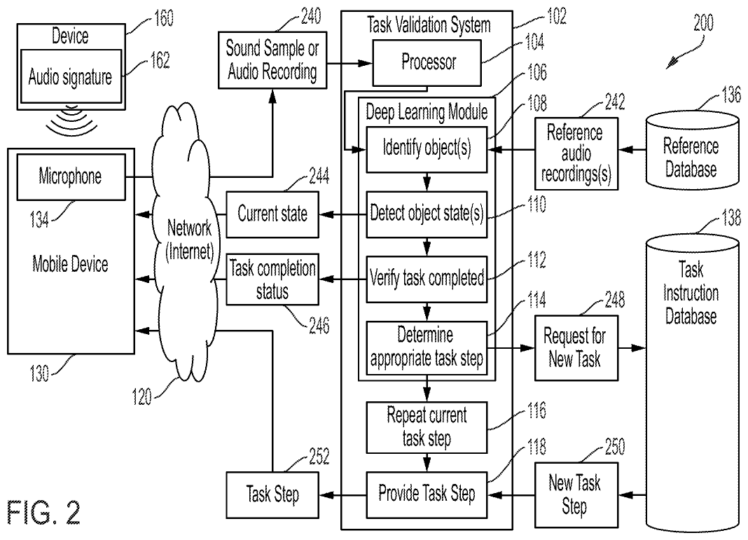

FIG. 2 shows a task validation system 200 according to other embodiments. The task validation system 200 in FIG. 2 has a similar configuration to the system 100 in FIG. 1. For example, the task validation system 200 comprises a computer system 102 in data communication with a user device 130 (e.g., mobile phone, smart glasses, personal digital assistant, tablet, laptop, desktop), a reference database 136 in data communication with the computer system 102, and a task instruction database 138 in communication with the computer system 102. The reference database 136 stores reference data associated with different states of a monitored device 160. The task instruction database 138 stores a plurality of workflow task steps. The computer system 102 includes a processor 104 and a deep learning module 106 that are configured in the same manner as described above with respect to FIG. 1.

As shown in FIG. 2, the user device 130 includes a microphone 134 or other similar sensor, such as a sound/acoustic sensor, a noise sensor, a vibration sensor, a decibel meter, an ultrasonic sensor configured to detect ultrasonic sound, or the like. Herein, the term “microphone” encompasses any one of or a combination of these devices. The microphone is adapted to detect or pick up an audio/acoustic signature 162 from the monitored device 160. An audio/acoustic signature refers to a sound or vibration that originates from the monitored device 160 or from a particular object(s) or component(s) of the monitored device, wherein the audio/acoustic signature corresponds to and/or is characteristic of a state or condition of the monitored device 160. For example, when a printer encounters a paper jam, it may produce a sound resembling a piece of paper crumpling as the paper is fed past the toner cartridge, and/or the printer may emit a distinct chime representative of this error condition. As another example, when a washer completes a wash cycle, it may emit a unique tune, beep, or click indicating this condition. Still another example, when the monitored device is a car that is idling, the car may produce a squealing sound that may be indicative of rotating parts (e.g., drive belt) are slipping on their pulleys. The user device 130 is configured to record a sound sample 240 via the microphone 134, wherein the sound sample 240 may comprise at least around one second of the audio/acoustic signature. In some embodiments, the sound sample 240 may comprise several seconds of the audio/acoustic signature or conversely may be a recording lasting only milliseconds, for example, from about 10 ms to about 900 ms, or from about 200 ms to about 700 ms, or from about 400 ms to about 600 ms. Also, the user device 130 may be configured to record multiple sound samples 240 at different times.

Upon capturing the sound sample(s) 240, the user device 130 is configured to transmit it over the network 120 to the validation task system 200. The at least one processor 104 of the computer system 102 is configured to perform audio signal processing on the sound sample(s) 240. For example, the user device 130 may transmit the sound sample(s) 240 in compressed format, which is then decompressed by the processor 104. The processor 104 may, in some instances, use noise cancellation or noise reduction to minimize unwanted sounds present in the sound sample. Other kinds of processing methods that the processor 104 may apply to the sound sample include, but are not limited to, equalization, filtering, level compression, echo and reverb removal or addition, other enhancements, or combinations thereof. In some embodiments, the processor 104 may convert the sound sample 240 from an analog signal to a digital signal, or vice versa. Also, if the user device 130 transmits a sound sample lasting a couple seconds, the processor 104 may be configured to extract a portion, clip, or sound bite to serve as an exemplary indicator input for analysis by the task validation system 200.

It is also noted that the user device 130 and the task validation system 200 may be configured to stream the sound sample. For example, while the microphone 134 is obtaining the sound sample, the user device 130 actively or simultaneously transmits the sound sample 240 for receipt by the processor 104. In turn, the processor 104 processes the sound sample 240 in real-time.

The deep learning module 106 performs the operations necessary for validating in real-time the completion of a task step currently performed by the user. The deep learning module 106 is built on machine learning and/or artificial intelligence and may be based on artificial neural networks with representation learning, in order to provide automated validation of task completion. In some embodiments, the deep learning module 106 includes computer audition, acoustic/audio fingerprinting, sound recognition, sound classification, or a combination thereof. Computer audition involves a module or system that provides for example auditory scene analysis, machine listening, and/or sound information retrieval to interpret and understand audio. Audio fingerprinting involves a system or module that analyzes an audio signal and extracts relevant characteristics of the audio content, for example converting the audio into a spectrogram comprising distinct frequency peaks and valleys. The deep learning module may utilize diverse machine learning models and multiple training libraries and may be based on locating features (e.g., peaks, changes in time and frequency) in a spectrogram of the sound sample. The deep learning module 106 has been trained to identify objects/components of the monitored device 160 and their respective states or conditions based on the sound sample(s) 240. In addition, or alternatively, the deep learning module 106 has been trained to identify the monitored device 160 as a whole and determine its state or condition from the sound sample(s) 240.

The deep learning module 106 is configured to analyze the indicator input (e.g., sound sample(s) 240), specifically identifying 108 an object of the monitored device 160 within the sound sample(s) 240 and detecting 110 a state of the object by comparing the sound samples(s) 240 to at least one reference datum (e.g., reference sound sample 242). The reference database 136 stores reference data, such as a plurality of reference sound samples 242 associated with different states or conditions of the monitored device 160 and/or a plurality of reference samples 242 associated with different states or conditions of an object/component of the monitored device 160. For each state of the monitored device 160 (and for example, for each state of an object/component of the monitored device 160), the reference database 136 may store only one reference sound sample 242 or multiple reference sound samples 242 related thereto. It is understood that with multiple reference sound samples, the deep learning module is able to better identify an object of the monitored device and detect its state (irrespective of the environment in which the monitored device is located and the background noise that may be present). However, even if the reference database contains one sound sample of the object in a particular state, the deep learning module still has the capacity to identify that object and detect that particular state of the object. The identification 108 and detection 110 may function by comparing and matching the sound sample(s) 240 to a reference sound sample(s) 242 (e.g., matching peaks or changes in spectrogram of the captured sound sample to those of the reference sound sample), and using metadata contained in the matching reference sample to detect the current state of the monitored device. The metadata may comprise a description of the state of the monitored device that is captured in the corresponding reference sample. Once the identification 108 and detection 110 have been performed, the deep learning module 106 may transmit the current state 244 to the user device 130 via the network 120. The user device 130 can then present the current state information of the monitored device 160 in its user interface.

As described above, the exit criteria or requirement for validation of a task step may be defined in the task step itself. For example, if a task step is to press down on a piece or button until an audible click sound is emitted, the task validation system 200 will listen for the click sound, and when it detects the click sound, the task step can be verified to be completed. As another example, during a workflow for installing a video doorbell, if the task step is to turn on power to the video doorbell and await for an audible tune indicating sufficient voltage/current is being supplied to the doorbell, the task validation system 200 will listen for the tune within the sound sample, and when it detects the tune, the task step can be verified to be completed. In some embodiments, the deep learning module is provided with training data, such as a set of reference sound samples and/or audio recordings of an object of the monitored device (e.g., printer front door), wherein each reference datum has been labeled with metatags or metadata describing the state or condition of the object (e.g., front door open or front door closed) captured in the respective datum. The deep learning module uses the information it receives from the training data to create a feature set for “no power present,” a feature set for “insufficient voltage/current,” and/or a feature set for “adequate power,” and builds a predictive model(s) accordingly. With each reference datum, the model becomes more complex and more accurate. As described above, the deep learning module may comprise artificial neural networks, comprising many layers, which drive deep learning. The training data may be stored in the reference database 136.

After the identification operation 108 and detection operation 110, the deep learning module verifies or validates 112 whether a current task step of the workflow has been completed by the user based on the detected state of the object of the monitored device 160. The deep learning module 106 may, in some embodiments, transmit a status 246 of task completion to the user device 130 via the network 120. This enables the user device 130 to indicate in real-time to the user whether and when a task step has been completed and when it is proper to move forward in the workflow.

When the deep learning module 106 analyzes the indicator input, e.g., sound sample(s) 240, from the user device 130 and detects the object state associated with the task step, the deep learning module verifies 112 that the task step has indeed been completed. The deep learning module 106 then determines an appropriate task step 114 to be presented on the user device 130. This determination operation 114 functions in response to the results of the verification operation 112. When there is a positive verification and validation of the current task step being completed, the deep learning module requests 248 a new task, i.e., next task step, in the workflow. In some embodiments, the task instruction database 138 uses information obtained from the computer system 102 and relating to the current task step that was completed and verified in order to decide which next task step 250 to send to the computer system 102. In response to a negative result of the verification operation 112, the determination operation 114 functions by indicating to the computer system 102 that the current task step needs to be repeated or still requires completion 116. In other embodiments, when the verification operation 112 concludes that the user has failed to complete the current task step, the determination operation 114 may instead send a request signal 248 to the task instruction database 138 to obtain a new task step 250 in the form of a troubleshooting step. This process may temporarily pause any instructions for the relevant workflow and initiate a troubleshooting workflow to be presented at the user device 130.

The computer system 102 performs an operation 118 of providing the appropriate task step to the user device 130, whether it be a new task step 250 in the workflow or a repeat 116 of the current task step which has yet to be completed. As such, a task step signal 252 is transmitted from task validation system 200 through the network 120 to the user device 130 for display.

Although the task validation system in FIG. 1 is configured to validate completion of a task step based on an image(s) 140 and the task validation system in FIG. 2 is configured to validate completion of a task step based on a sound sample(s) 240, there are other embodiments where the task validation system receives both an image(s) and a sound sample(s) from the user device 130. In this case, the processor 104 processes both types of indicator inputs, and the deep learning module 106 performs the identification 108, detection 110, and verification 112 based on both types of indicator inputs. The deep learning module thus utilizes the combination of image and sound to validate a current task step. The reference database 136 accordingly stores a plurality of sample images and sample sound recordings.

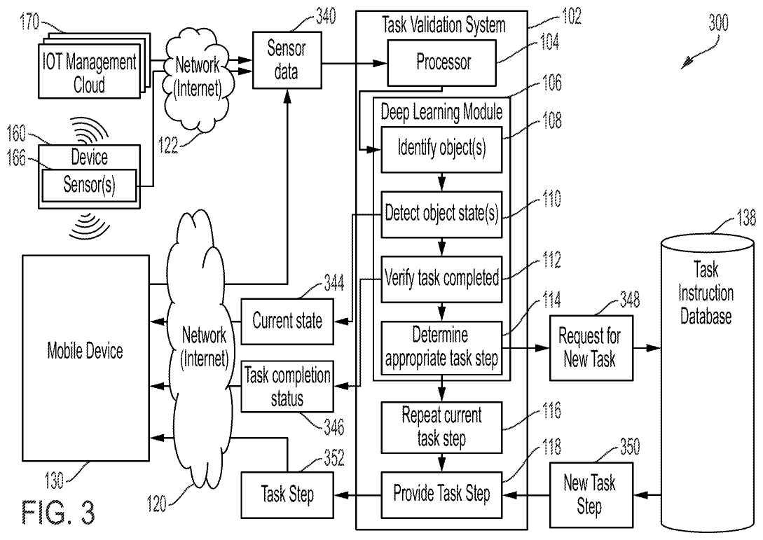

FIG. 3 illustrates a task validation system 300 according to some embodiments. Like the systems 100 and 200, the task validation system 300 is designed to deliver workflow task steps to a user (e.g., user device 130) and provide guidance as the user proceeds through the workflow. The task validation system 300 comprises a computer system 102 in data communication with a user device 130 (e.g., mobile phone, smart glasses, personal digital assistant, tablet, laptop, desktop) and a task instruction database 138 in communication with the computer system 102. The task instruction database 138 stores a plurality of workflow task steps. The computer system 102 includes a processor 104 and a deep learning module 106.

The monitored device 160 in FIG. 3 may be a smart device that directly or indirectly provides information about its state or the state of any one or more of its components. The monitored device includes one or more sensors 166 that detect or measures different properties, states, and/or conditions of the monitored device or any part thereof. For example, in the case of a printer, there may be a sensor 166 that detects whether the front door is open or closed, a sensor that detects whether the toner cartridge is aligned or misaligned in the drum unit, a sensor that measures the amount of ink left in the toner cartridge, a sensor that detects a paper obstruction in a particular section of the conveyor system, etc. In some embodiments, the monitored smart device 160 is connected to an IOT (internet of things) management cloud system 170, through wireless means (e.g., Wi-Fi, Bluetooth, Zigbee, Z-wave, cellular), wired transmission lines (e.g., ethernet, twisted pair cables, coaxial cables, fiber optic cables), or a combination of both. The sensor data 340 generated by the sensor(s) 166 is transmitted to the IOT management cloud 170, which then passes the sensor data 340 through a network 122 to the task validation system 300. The network 122 may be similar in characteristics to the network 120 through which the user device 130 is in communication with the task validation system 300. In some instances, the network 122 and network 120 together constitute one network. To ensure security and/or prevent intrusion, the network 122 may be a secure, authenticated connection between the IOT management cloud 170 and the task validation system 300.

In addition to the IOT management path, or alternatively, the sensor data 340 may be transmitted from the monitored device 160 directly (i.e., bypassing the IOT management cloud system 170) to the task validation system 300 via the network 122. In some embodiments, the user device 130 may include a transceiver (not shown) which requests information from the sensor(s) 166 and receives sensor data 340, for example by wireless means. The user device 130 subsequently transmits the sensor data 340 via the network 120 to the task validation system 300.

It is also noted that the monitored smart device 160, IOT management cloud system 170, and/or the user device 130 may be configured to stream the sensor data in real-time to the task validation system 300. For example, while the sensor 166 is obtaining data or measurements, the monitored smart device 160 is actively transmitting the sensor data 340 to the IOT management cloud 170, which actively passes the sensor data 340 onto the task validation system 300. In turn, the processor 104 processes the sensor data 340 in real-time. The processor 104 may perform various processing techniques including but not limited to denoising, data outlier detection, missing data imputation, and data aggregation. Also, the processor 104 may conduct data fusion on the sensor data with other sources.

The deep learning module 106 performs the operations necessary for validating in real-time the completion of a task step currently performed by the user. The deep learning module 106 may include machine learning and/or artificial intelligence and may be based on artificial neural networks in order to provide automated validation of task completion. The deep learning module 106 is configured to analyze the indicator input (e.g., sensor data 340), specifically identifying 108 an object of the monitored device 160. In some embodiments, the sensor data 340 already contains information indicating the object to which it corresponds. As such, the identification operation 108 simply extracts the identifying information from the sensor data 340. The deep learning module 106 thereafter detects 110 a state of the identified object. In some embodiments, the sensor data 340 already contains information that indicates the object state or condition. Accordingly, the detection operation 110 simply extracts the state information from the sensor data 340. In addition to the above, or alternatively, the deep learning module 160 may identify an object of the monitored device 160 and detect a state of the object by comparing the sensor data to at least one reference datum (e.g., reference sensor data point, previously recorded sensor data). A reference database 136 (not shown in FIG. 3) may be in data communication with the deep learning module 106 and store the reference data.

After the identification operation 108 and detection operation 110, the deep learning module verifies or validates 112 whether a current task step of the workflow has been completed by the user based on the detected state of the object of the monitored device 160. The task validation system 300 includes a verification unit 112 that functions in a similar manner to those described in FIGS. 1 and 2. For example, the verification unit 112 transmits a current state 344 of the monitored device to the user device 130 via the network 120. The task validation system 300 also includes an appropriate task determination unit 114 that functions in a similar manner to those described in FIGS. 1 and 2. For example, when there is a positive verification and validation of the current task step being completed, the deep learning module requests 348 a new task, i.e., next task step, in the workflow. The task instruction database 138 uses information obtained from the computer system 102 and relating to the current task step that was completed and verified in order to decide which next task step 350 to send to the computer system 102. In response to a negative result provided by the verification unit 112, the appropriate task determination unit 114 indicates to the computer system 102 that the current task step needs to be repeated or still requires completion 116. In other embodiments, when the verification unit 112 concludes that the user has failed to complete the current task step, the appropriate task determination unit 114 may instead send a request signal 348 to the task instruction database 138 to obtain a new task step 350 in the form of a troubleshooting step.

The computer system 102 performs an operation 118 of providing the appropriate task step to the user device 130, whether it be a new task step 350 in the workflow or a repeat 116 of the current task step which has yet to be completed. As such, a task step signal 352 is transmitted from task validation system 300 through the network 120 to the user device 130 for display.

Although FIG. 3 shows the task validation system 300 receiving only sensor data, there are some embodiments where it is configured to receives sensor data 340 as well as an image(s) 140 and/or a sound sample(s) 240 from the user device 130. In this case, the processor 104 may process at least two types of indicator inputs, and the deep learning module 106 may perform the identification 108, detection 110, and verification 112 based on the combination of sensor data and images, or the combination of sensor data and sound samples, or the combination of sensor data, images, and sound samples.

In some embodiments, the task validation system 100, 200, 300 may comprise the user device 130. In other embodiments, a portion of the task validation system 100, 200, 300 may reside or be embodied in the user device 130. For example, the user device 130 and the computer system 102 of the task validation system may constitute a single device.

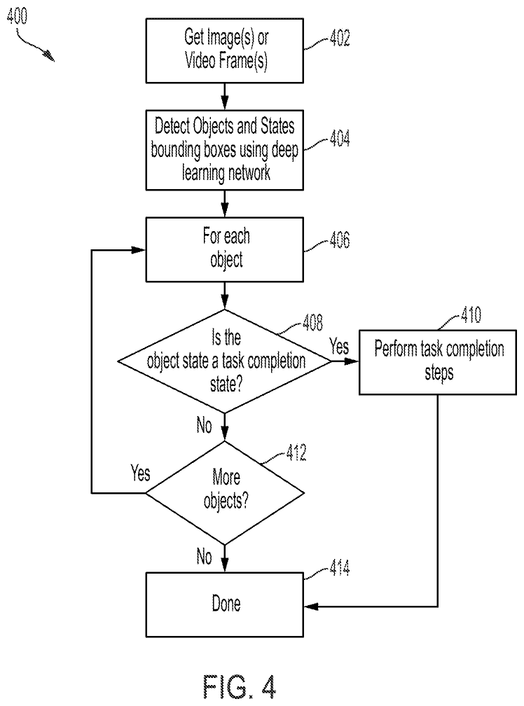

FIG. 4 depicts an exemplary method 400 for validating task completion. The method 400 corresponds to the task validation system shown in FIG. 1. The method comprises a step 402 of getting an image(s) or video frame(s) of the monitored device. Step 402 relates to the user device 130 capturing an image and/or a video of a particular component or object of the monitored device 160 via the camera 132 and thereafter, the task validation system receiving the image(s) or video frame(s). Although not shown, the method 400 may include a step of processing the image(s) or video frame(s) by the processor 104. Thereafter, a step 404 comprises detecting an object of the monitored device and its current state or condition. Step 404 is performed by the deep learning module 106, and for example by the identification unit 108 and the detection unit 110. In some embodiments, the detection step 404 may involve object localization where the deep learning module draws a bounding box around the object of interest within the image(s) or video frame(s). The bounding box is an abstract area defining spatial location that acts as a reference point for object detection. This helps the machine learning and/or artificial intelligence find the object and save computational power. The method 400 further includes a step 406, wherein for each detected object of the monitored device 160, the task validation process is conducted. That is, in step 408, it is determined whether the object state is a task completion state. Step 408 is performed by the verification unit 112. If step 408 results in “yes,” then step 410 comprises performing task completion steps. For example, the appropriate task step determination unit 114 sends a request to the task instruction database 138 to obtain the next task step. Once the next task step has been transmitted to the user device 130, the same steps 402-410 can be repeated for the next task step, which essentially becomes the current task step. It is noted that task completion steps could optionally take users down different paths in the decision tree shown in FIG. 4. After all instructions of a workflow have been validated as complete, the method is done 414. If step 408 results in a “no,” step 412 comprises determining whether there are other objects of interest in the image(s) or video frame(s). If yes, then the method returns to step 406. If there are no additional objects of interest in the image(s) or video frame(s), then the method is done 414.

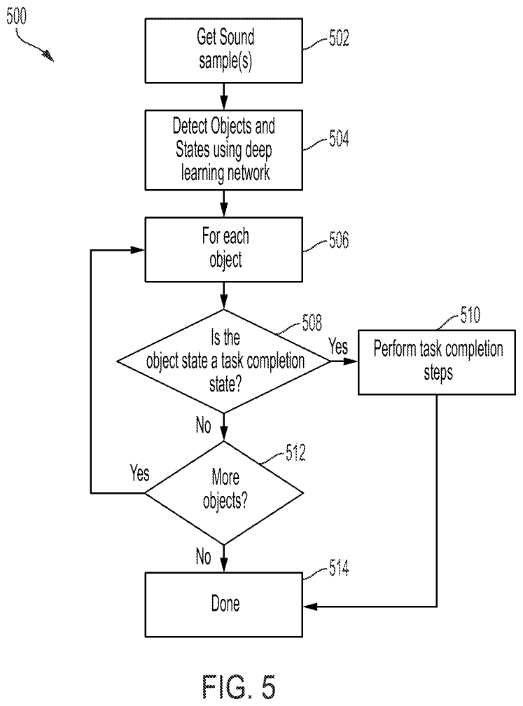

FIG. 5 depicts an exemplary method 500 for validating task completion. The method 500 corresponds to the task validation system shown in FIG. 2. The method 500 is similar to the method 400, except the indicator input is a sound sample. In particular, the method comprises a step 502 of getting at least one sound sample of an audio signature 162 of the monitored device 160. Step 502 relates to the microphone of the user device 130 detecting the audio signature and recording it as a sound sample. The task validation system then receives the sound sample for processing. Thereafter, a step 504 comprises detecting an object of the monitored device and its current state or condition. Step 504 is performed by the deep learning module 106, and for example by the identification unit 108 and the detection unit 110. In some embodiments, the detection step 504 may involve the deep learning module drawing a bounding box in the time-frequency spectrum of the sound sample. The method 500 further includes a step 506, wherein for each detected object of the monitored device 160, the task validation process is conducted. Steps 510-514 are the same as steps 410-414 and thus are not described in detail.

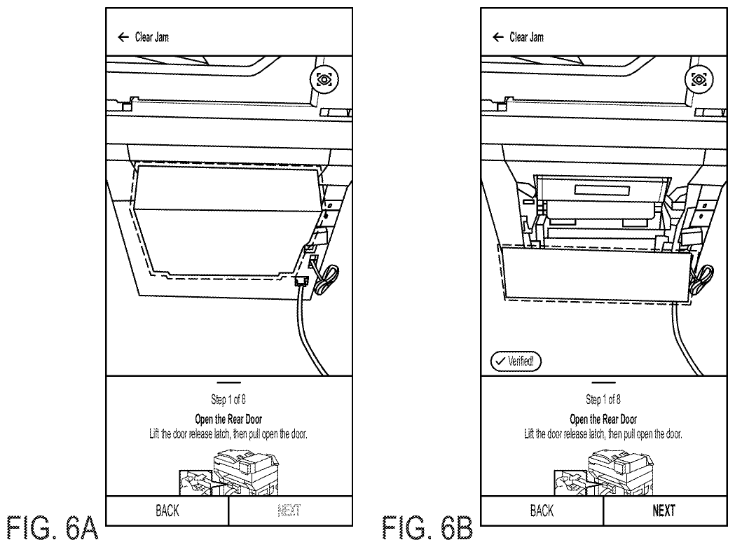

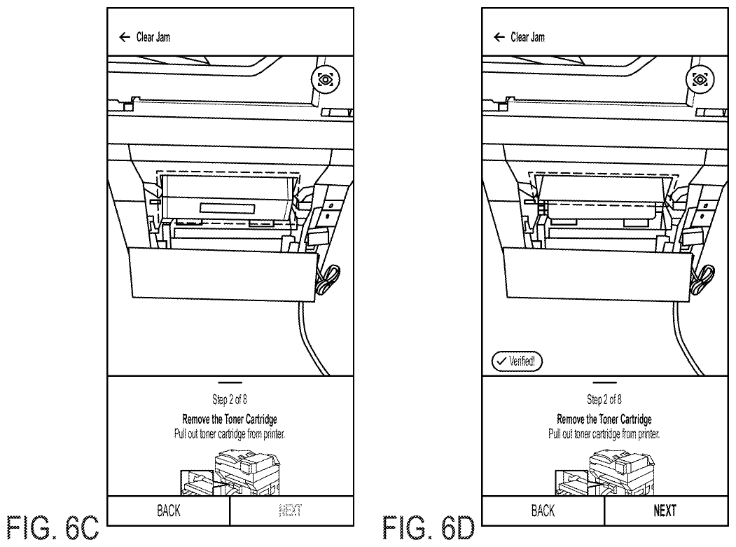

FIGS. 6A-6D show the mechanism by which the task validation system, according to the above disclosed embodiments, provides guidance through instructions or task steps in a workflow and provides validation that a current task step is completed. Using the workflow of clearing a paper jam as an example, FIG. 6A depicts a graphical user interface of the user device 130 (e.g., mobile device) displaying the task step of “Open the Rear Door.” As the camera 132 of the user device is directed at the printer, an augmented reality (AR) module superimposes a computer-generated highlighted outline (illustrated by dashed lines in FIG. 6A) around the relevant object of the monitored device 160 (e.g., rear door) that is associated with the current task step in order to assist the user in locating the object. The AR operation may be performed in the computer system 102, which receives an image(s) or video(s) from the user device 130. In some embodiments, the computer system 102 is receiving the image or video as a live stream and is actively adjusting superimposition of the highlighted outline in response to what view the camera is providing. Alternatively, the graphical user interface of the user device 130 may display an animation of how the object must be manipulated to complete the current task step (e.g., animation showing the rear door of the printer being placed in an open state).

As shown in FIG. 6A, a “NEXT” button is disabled, which prevents the user from proceeding onto the next task step in the workflow until the current task step has been validated as complete. Once the user performs the current task step correctly, the task validation system validates the completion of the task step, at which point the graphical user interface is updated to display a “Verified” symbol, as shown in FIG. 6B. In addition, the “NEXT” button is enabled, thereby allowing the user to proceed to the next task step. Once the “NEXT” button is pressed, the user device 130 may transmit a signal to the task validation system to indicate that it is ready to receive the next task step in the workflow. In other embodiments, once the current task step has been verified as being completed, the graphical user interface may automatically adjust its display to show the next task step, without waiting for the user to press the “NEXT” button.

In FIG. 6C, the next task step is displayed by the graphical user interface and thus becomes the new current task step. In particular, the task step of “Remove the Toner Cartridge” is displayed, while the “NEXT” button is once again disabled. The augmented reality (AR) module superimposes a computer-generated highlighted outline (illustrated by dashed lines in FIG. 6C) around the relevant object of the monitored device 160 (e.g., toner cartridge) that is associated with the current task step in order to assist the user in locating the object. Once the user performs the current task step correctly, the task validation system validates the completion of the task step, at which point the graphical user interface is updated to display a “Verified” symbol, as shown in FIG. 6D. In addition, the “NEXT” button is enabled, thereby allowing the user to proceed to the next task step.

Although examples have been described with respect to the task of opening the rear door of a printer in the workflow for clearing a paper jam, the above task validation system, application, and method is applicable to any kind of workflow and may involve any type of monitored device.

It will be appreciated that variants of the above-disclosed and other features and functions, or alternatives thereof, may be combined into many other different systems, applications, or methods. Various presently unforeseen or unanticipated alternatives, modifications, variations, or improvements therein may be subsequently made by those skilled in the art which are also intended to be encompassed by the following claims. The claims can encompass embodiments in hardware, software, or a combination thereof.

What is claimed is:

1. A system for validating workflow task completion, comprising:
a computer in data communication with a user device that is configured to provide instructions related to a workflow and that is configured to obtain an indicator input associated with a state of a monitored device;
the computer being configured to receive the indicator input;
the computer having a processor that is configured to process the indicator input and a deep learning module that is configured to receive the processed indicator input;
a reference database in communication with the computer and configured to store reference data associated with different states of the monitored device;
a task database in communication with the computer and configured to store a plurality of workflow task steps;
the deep learning module being configured to identify an object of the monitored device within the processed indicator input and detect a state of the object by comparing the processed indicator input to at least one reference datum from the reference database;
the deep learning module being configured to validate whether a current task step of the workflow is completed based on the detected state of the object;
the computer, in response to the validation, being configured to obtain another task step of the workflow based on a result of the validation and adjust the instructions provided by the user device.

2. The system of claim 1, wherein the indicator input includes:
at least one image or at least one frame of a video obtained by an imaging sensor of the user device; and/or
at least one sound sample obtained by a microphone or sound sensor of the user device.

3. The system of claim 2, wherein the deep learning module is configured to utilize:
computer vision to identify the object within the at least one image or the at least one frame and to detect the state of the object; and/or
at least one of computer audition or audio fingerprinting to identify the object within the at least one sound sample and to detect the state of the object.

4. The system of claim 2, wherein the reference data which is configured to be stored in the reference database includes:
a plurality of reference images associated with the different states of the monitored device; and/or
a plurality of reference audio recordings associated with the different states of the monitored device.

5. The system of claim 4, wherein:
each of the plurality of reference images is configured to contain metadata comprising a description of at least one object depicted in the respective reference image and a description of state of each of the at least one object depicted in the reference image; and/or
each of the plurality of reference audio recordings is configured to contain metadata comprising a description of at least one object captured in the respective reference audio recording and a description of state of each of the at least one object captured in the reference audio recording.

6. The system of claim 1, wherein when the result of the validation confirms the current task step is completed, said another task step obtained by the computer is a subsequent task step which follows the current task step, the subsequent task step being retrieved from the task database.

7. The system of claim 1, wherein when the result of the validation indicates the current task step is incomplete, said another task step obtained by the computer is either a repeat of the current task step or a troubleshooting step retrieved from the task database.

8. The system of claim 1, wherein in response to the validation, the computer is configured to send a request signal to the task database, said request signal requesting for a new task step and containing information obtained by the computer and relating to the current task step that was validated as being complete, and wherein the task database is configured to select said another task step for transmission to the computer based on said information.

9. The system of claim 1, wherein:
the deep learning module is configured to identify a plurality of objects within the processed indicator input and to detect a state of each of the objects by comparing the processed indicator input to the at least one reference datum; and
the deep learning module is configured to validate whether the current task step of the workflow is completed based on the detected states of at least two of the objects.

10. The system of claim 1, wherein the computer includes the reference database and/or the task database.

11. The system of claim 1, wherein the indicator input is configured to be received by the computer as a substantially live stream, and wherein the computer processes the indicator input in real-time as the indicator input is being received.

12. The system of claim 1, wherein in response to the deep learning module determining a failure in completion of the current task step, the computer is configured to prevent the user device from providing a next task step in the workflow until completion of the current task step is obtained and validated.

13. The system of claim 1, further comprising the user device, which provides augmented reality-based guidance for said instructions related to the workflow.

14. A system for validating workflow task completion, comprising:
a user device that is configured to provide instructions for a workflow which involves monitoring a device;
a computer in data communication with the user device, the computer being configured to receive sensor data originating from the monitored device via a network connection, the sensor data being indicative of a state of the monitored device and configured to be received by the computer as an indicator input;
the computer having a processor that is configured to process the indicator input and a deep learning module that is configured to receive the processed indicator input;
a task database in communication with the computer and configured to store a plurality of workflow task steps;
the deep learning module being configured to identify an object of the monitored device and detect a state of the object based on the processed indicator input;
the deep learning module being configured to validate whether a current task step of the workflow is completed based on the detected state of the object;
the computer, in response to the validation, being configured to obtain another task step of the workflow based on a result of the validation and adjust the instructions provided by the user device.

15. The system of claim 14, wherein the computer is configured to receive the sensor data from an internet of things (IoT) management system, which is configured to collect the sensor data from the monitored device.

16. The system of claim 14, wherein the user device is configured to obtain the sensor data directly from the monitored device and transmit the sensor data to the computer via said network connection.

17. The system of claim 14, further comprising a reference database in communication with the computer and configured to store reference data associated with different states of the monitored device;
wherein the user device is configured to obtain a second indicator input associated with a second state of the monitored device;
the computer being configured to receive said second indicator input, and the processor being configured to process said second indicator input,
the deep learning module being configured to receive said second indicator input from the processor, identify said object or a second object of the monitored device within said second indicator input, and detect a second state of said object or said second object by comparing said second indicator input to at least one reference datum from the reference database;
the deep learning module being configured to validate whether another current task step of the workflow is completed based on the second state.

18. The system of claim 17, wherein:
said second indicator input includes at least one image or at least one frame of a video obtained by the user device, the reference data which is stored in the reference database includes a plurality of images associated with the different physical states of the monitored device, and the deep learning module being configured to utilize computer vision to identify said object or said second object within the at least one image or the at least one frame and to detect said second state; and/or
said second indicator input includes at least one sound sample obtained by the user device, the reference data which is stored in the reference database includes a plurality of audio recordings associated with the different physical states of the monitored device, and the deep learning module is configured to utilize at least one of computer audition or audio fingerprinting to identify said object or said second object within the at least one sound sample and to detect said second state.

19. A method of validating workflow task completion, comprising:
providing a computer in data communication with a user device that is configured to provide instructions related to a workflow, wherein the workflow involves monitoring a device;
obtaining an indicator input with the user device, the indicator input being associated with a state of a monitored device;
transmitting the indicator input to a deep learning module of the computer,
using the deep learning module to identify an object of the monitored device within the indicator input and to detect a state of the object by comparing the processed indicator input to at least one reference datum from a reference database, wherein the reference database is configured to be in communication with the computer and store reference data associated with different states of the monitored device;
validating, via the deep learning module, whether a current task step of the workflow is completed based on the detected state of the object; and
in response to the validation, obtaining another task step of the workflow and adjusting the instructions provided by the user device based on a result of the validation, wherein the computer obtains said another task step from a task database which is configured to store a plurality of workflow task steps.

20. The method of claim 19, further comprising:
capturing an image or a video with an imaging sensor of the user device and using said image or said video as the indicator input, and analyzing the indicator input with computer vision to identify the object within the image or the video and to detect the state of the object; and/or
capturing a sound sample with a microphone or sound sensor of the user device and using said sound sample as the indicator input, and analyzing the indicator input with at least one of computer audition or audio fingerprinting to identify the object within the sound sample and to detect the state of the object.
